(19) United States
(12) Patent Application Publication
(10) Pub. No.: US 2014/0114788 A1
(43) Pub. Date: Apr. 24, 2014

(54) DETERMINING A PRICE FOR CONTENT

(71) Applicants: Jacob Baskin, Brooklyn, NY (US); Martin Pal, Maplewood, NJ (US)

(72) Inventors: Jacob Baskin, Brooklyn, NY (US); Martin Pal, Maplewood, NJ (US)

(21) Appl. No.: 13/655,589

(22) Filed: Oct. 19, 2012

(51) Int. Cl. G06Q 30/08

(52) U.S. Cl. 705/26.3

(57) ABSTRACT

Example techniques for determining a price for content may include the following operations: obtaining bids from content providers, where the bids correspond to amounts that the content providers will pay to present content on a portal hosted by a publisher; obtaining surcharges corresponding to an effect on the publisher of presenting content from the content providers on the portal; using one or more processing devices to adjust the bids in accordance with corresponding surcharges to thereby produce adjusted bids; comparing the adjusted bids to determine a winner of an auction to present content on the portal hosted by the publisher; determining a price for the winner to pay based on the surcharge; and charging the winner the price for presenting content on the portal.

### BACKGROUND

This disclosure relates generally to determining a price for content.

The Internet provides access to a wide variety of resources. For example, video, audio, and Web pages are accessible over the Internet. These resources present opportunities for other content (e.g., advertising or non-advertising content, such as audio, video, or the like) to be provided with the resources. For example, a Web page can include slots in which content can be presented. Similarly, such slots can be part of television programming.

Slots can be allocated to content providers (e.g., advertisers). In some systems, a network can be used to allocate content to the slots based, e.g., on various factors relating to the content and the context in which it is to be presented. For example, the content can be allocated based, in part, on keywords input to a system, such as a search engine. An auction can be performed for the right to present advertising in a slot. In the auction, content sponsors provide bids specifying amounts that the content sponsors are willing to pay for presentation of their content. Typically, the winning bidder is given the right to present content.

### SUMMARY

Example techniques for determining a price for content may include the following operations: obtaining bids from content providers, where the bids correspond to amounts that the content providers will pay to present content on a portal hosted by a publisher; obtaining surcharges corresponding to an effect on the publisher of presenting content from the content providers on the portal; using one or more processing devices to adjust the bids in accordance with corresponding surcharges to thereby produce adjusted bids; comparing the adjusted bids to determine a winner of an auction to present content on the portal hosted by the publisher; determining a price for the winner to pay based on the surcharge; and charging the winner the price for presenting content on the portal. The foregoing example techniques may include one or more of the following features, either alone or in combination.

Surcharges may be different for different content providers, and the effect may include a cost borne by the publisher of presenting a content item from a content provider. The cost may include a monetary effect on a business of the content provider of presenting the content item.

Surcharges may be obtained from the publisher. Each surcharge may correspond to a content item from a content provider. At least one of the surcharges may be based on an adjusted bid of a winner of a prior auction.

The surcharges may be based on one or more of the following factors: a type of the content, subject matter of the content, functionality of the content, a developer of the content, features included in the content, an industry associated with the content, whether the content is for a competitor of the publisher, and links associated with the content. Each of the surcharges may be determined using a linear classifier that multiplies values corresponding to one or more of the factors by corresponding weights and that processes resulting products to produce a surcharge.

The content may be advertising, and the content providers may be advertisers. The content providers may include Web site providers, the advertising may include an online advertisement (ad), and the surcharges may be based on one or more of the following: whether the ad is expandable, subject matter of the ad, whether the ad includes pixel tags, an ad agency that developed the ad, whether the ad contains audio, whether the ad contains video, whether video contained in the ad starts when a page is loaded or requires interaction before starting, an industry that the ad represents, whether the ad is for a competitor of the publisher, and whether the ad clicks-through to a Web page that meets one or more predefined criteria regarding Web page quality.

The content providers may be television providers, the advertising may be a television advertisement (ad), and the surcharges may be based on one or more of the following: subject matter of the ad, an industry that the ad represents, and whether the ad is for a competitor of the publisher.

Determining the price may include adding, to an adjusted bid of the winner, a surcharge corresponding to the adjusted bid of the winner to produce the price. Determining the price may include obtaining an adjusted bid of a content provider who placed second in the auction behind the winner; and adding, to the adjusted bid of the content provider who placed second in the auction, a surcharge corresponding to the adjusted bid of the winner to produce the price.

The systems and techniques described herein, or portions thereof, may be implemented as a computer program product that includes instructions that are stored on one or more non-transitory machine-readable storage media, and that are executable on one or more processing devices. The systems and techniques described herein, or portions thereof, may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of an example system for distributing content to users over a network.

FIG. 2 is a block diagram of an example content exchange system.

FIG. 3 is a flow diagram of an example process for determining a price of content.

FIG. 4 shows examples of computing devices on which the processes described herein, or portions thereof, may be implemented.

Like reference symbols in the various drawings indicate like elements.

### DETAILED DESCRIPTION

Described herein are techniques for determining a price of content, such as advertisements, that can be included in other content, such as web pages or multimedia presentations. In general, advertisers pay content providers for presenting their advertising content to users in association with their web pages or other primary content.

Not all advertising content, however, is created equal. Relative to the web page or other media content in which advertising content is to be provided, some advertising content may be more or less desirable than others. For example, the operator of a Web site directed toward healthy lifestyles may prefer an advertisement for an organic foods market over an advertisement for fast food. In another example, the provider of a family-oriented television program may prefer to show a commercial for a “G” rated movie rather than one for an “R” rated movie.

The choice of which advertising content to present can also have a financial impact upon the web page or other media content in which the advertising content is presented. For example, the presentation of less desirable content may hurt a web page's reputation or image, and this may cause users to become fractionally less likely to revisit the page. In such examples, the display of some advertisements can have different impacts and resulting costs to the web page providers. In general, the higher negative impact of certain advertising content upon a content provider can be offset by adding a content-dependent surcharge to the cost of presenting the advertising content, and this surcharge can be included in a bidding process for selecting the advertising content that will be presented.

The processes described herein may be implemented in any appropriate network environment, with any appropriate devices and computing equipment. An example of such an environment is described below.

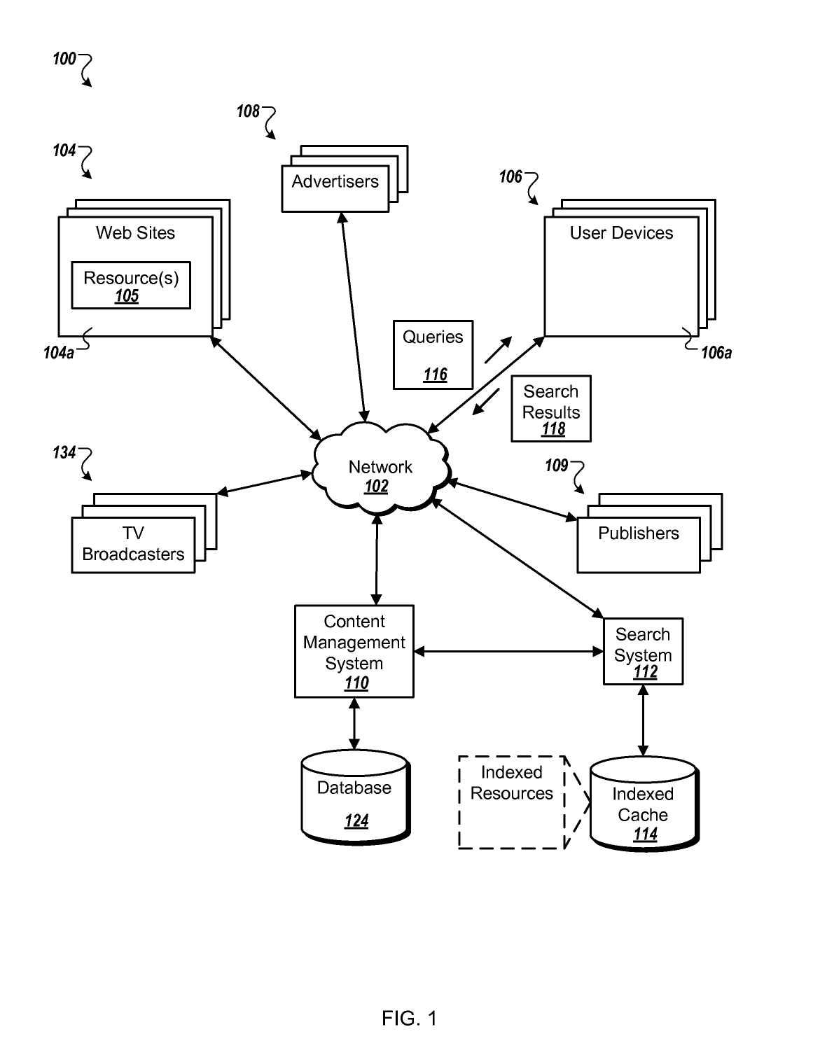

FIG. 1 is a block diagram of an example network environment 100 that may be used in the processes described herein for determining a price for content (e.g., ads).

As shown in FIG. 1, network 102 connects various entities, such as Web sites 104, user devices 106, content providers (e.g., advertisers 108), online publishers 109, television broadcasters 134, and a content management system 110. In this regard, example environment 100 may include many thousands of Web sites 104, user devices 106, and content providers (e.g., advertisers 108). Entities connected to network 102 include and/or connect through one or more servers. Each such server may be one or more of various forms of servers, such as a Web server, an application server, a proxy server, a network server, or a server farm. Each server can include one or more processing devices, memory, and a storage system.

Network 102 can represent a communications network that can allow devices, such as a user device 106a, to communicate with entities on the network. Network 102 can include one or more networks. The network(s) may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication may occur through a radio-frequency transceiver. In addition, short-range communication may occur, such as using a Bluetooth, Wi-Fi, or other such transceiver.

In FIG. 1, Web sites 104 may include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 may be any appropriate data that can be provided over network 102. A resource 105 can be identified by a resource address that is associated with the resource 105. Resources 105 can include HypterText Mark-up Language (HTML) pages, word processing documents, portable document format (PDF) documents, images, video, and news feed sources, to name a few. Resources 105 can also include content, such as words, phrases, images, video and sounds, that may include embedded information (such as meta-information hyperlinks) and/or embedded instructions (such as JavaScript scripts).

To enable searching of resources 105, environment 100 can include a search system 112, as described below, that identifies resources 105 by crawling and indexing resources 105 provided by the content publishers on the Web sites 104. Data about the resources 105 can be indexed based on the resource 105 to which the data corresponds. Indexed and, optionally, cached copies of the resources 105 that match input keywords can be retrieved and output.

An example user device 106a is an electronic device that is under control of a user and that is capable of requesting and receiving resources over the network 102. A user device may include one or more processing devices, and may be, or include, a mobile telephone (e.g., a smartphone), a laptop computer, a handheld computer, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access a search index to identify resources 105 that are relevant to the search query 116. As described below, the search system 112 identifies resources 105 in the form of search results 118 and returns the search results 118 to a user device 106 in search results pages. A search result 118 may include data generated by search system 112 that identifies a resource 105 that is responsive to a particular search query 116, and that includes a link to the resource 105. An example search result 118 can include a Web page title, a snippet of text or a portion of an image extracted from the Web page, and the URL (Unified Resource Location) of the Web page.

Content management system 110 may be used for selecting and providing content in response to requests for content. Content management system 110 also can update database 124 based on activity of a user. In this regard, the database 124 can store a profile for the user which includes, for example, information about past user activities, such as visits to a place or event, past requests for resources 105, past search queries 116, other requests for content, social network profiles and connections, Web sites visited, or interactions with content. In some implementations, the information in database 124 can be derived, for example, from one or more of a query log, an advertisement (“ad”) log, or requests for content. The database 124 can include, for each entry, a cookie identifying the user, a timestamp, an IP (Internet Protocol) address associated with a requesting user device 106, a type of usage, and details associated with the usage.

When a resource 105 or search results 118 are requested by a user device 106, content management system 110 can receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116. For example, the content management system identifies content, such as advertising, that is associated with keywords that match, or are substantially similar to, the input keywords (e.g., are a variant of the keywords, such as “car” or “cars”). When a match is detected, content management system 110 outputs the corresponding content. The processes described herein may be used to serve customized ads based, e.g., on input keywords or other search query content.

Based at least in part on data included in a request, content management system 110 can select content that is eligible to be provided in response to the request (referred to as “eligible content items”). For example, eligible content items can be eligible ads having characteristics matching the characteristics of ad slots and that are associated with user-provided keywords (e.g., terms in the input search query). The universe of eligible content items (e.g., ads) can be narrowed by taking into account other factors, such as the content of previous search queries 116. For example, content items corresponding to historical search activities of the user including, e.g., search keywords used, particular content interacted with, sites visited by the user, etc. may also be used in the selection of eligible content items by the content management system 110.

In some implementations, the eligibility of content items may be determined by a combination of two or more characteristics. For example, an identified advertisement may include a characteristic that indicates that the ad may have a negative impact upon on the web page in which the ad may be presented (e.g., a fast food ad on a health Web site), in which case the ad may be charged an additional fee by the publisher in order to sufficiently offset the cost of the ad's negative impact. If the ad's price, even once this surcharge is deducted, is sufficient to meet all appropriate other selection criteria, then the ad may be identified as being eligible for presentation.

Content management system 110 can select the eligible content items that are to be provided for presentation in slots of a resource 105 or search results page 118 based, at least in part, on results of an auction. For example, for eligible content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid can specify an amount that a content provider is willing to pay for each 1000 impressions (i.e., presentations) of the content item, referred to as a CPM (cost per mille) bid. Alternatively, the bid can specify an amount that the content provider is willing to pay for a selection (i.e., a click-through) of the content item or a conversion following selection of the content item. In this case, the bid will be multiplied by the expected probability of the selection occurring within 1000 impressions. The resulting bid is referred to as an eCPM (or expected CPM) bid. The selected content item can be determined based on the bids alone, or based on the bids of each bidder being multiplied by one or more factors, such as quality scores derived from content performance, landing page scores, and/or other factors.

In some implementations, a content provider can bid for an identified audience of users. For example, one or more of the publishers 109 and/or the content management system 110 may provide one or more audiences of users, where each user in the audience matches one or more targeting criteria, such as matching one or more demographics. An audience of users may be represented, for example, as a user list. User lists or other representations of audiences may be stored, for example, in a database 124. A bid from a content provider can specify, for example, an amount that the content provider is willing to pay for each 1000 impressions (i.e., presentations) of the content item to a particular audience of users. The content management system 110 may, for example, manage the presentation of the content item to users included in a particular audience and may manage charging of the content provider for the impressions and distributing revenue to the publishers 109 based on the impressions.

In some implementations, TV (Television) broadcasters 134 produce and present television content on TV user devices (not shown), where the TV content may be organized into one or more channels. The TV broadcasters 134 may include, along with the TV content, one or more content slots in which other content (e.g., advertisements) may be presented. For example, a TV network may sell slots of advertising to advertisers in TV programs that they broadcast. Some or all of the content slots may be associated with keywords that relate, e.g., to the television programs in broadcast on a particular channel.

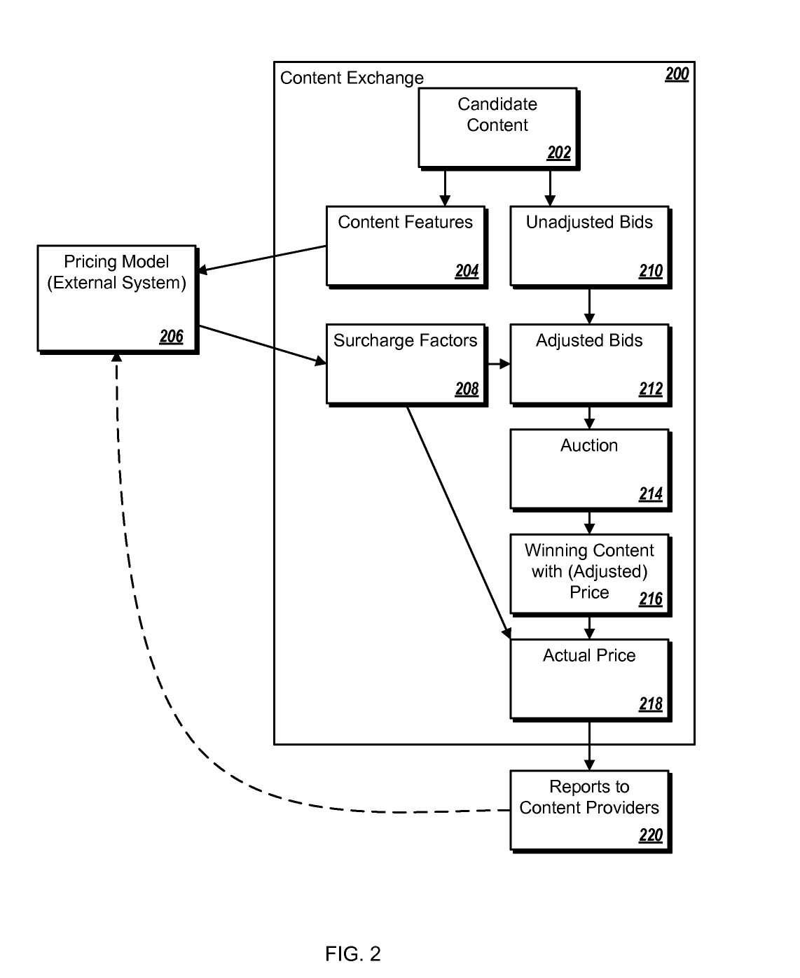

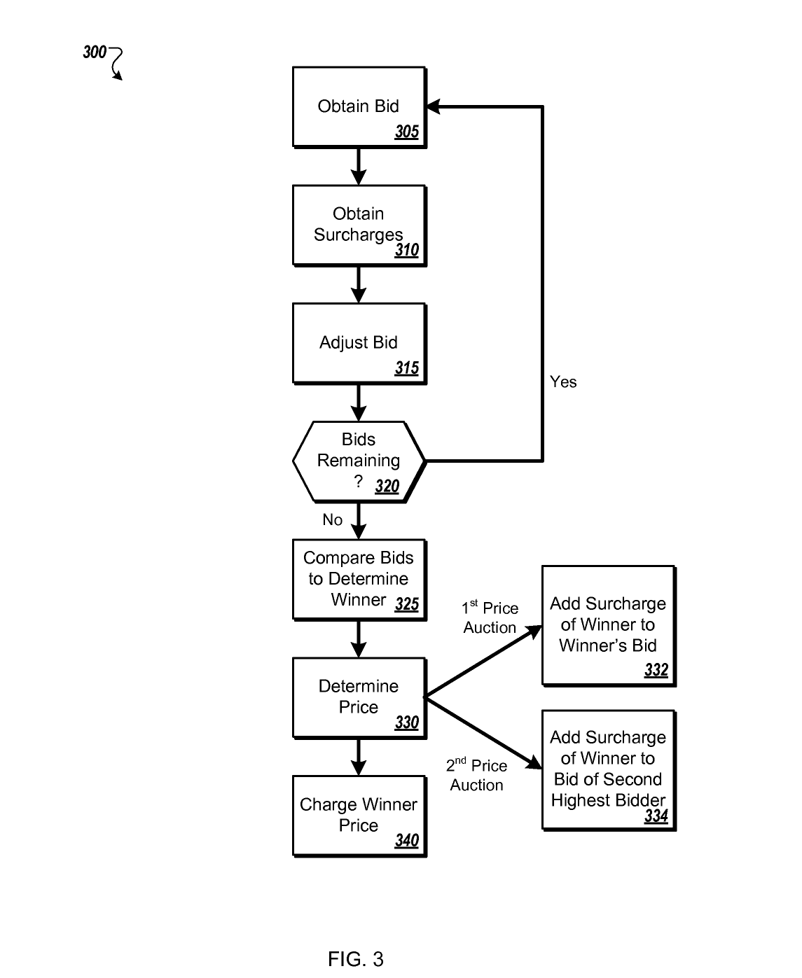

FIG. 2 is a block diagram of an example content exchange system 200. In some implementations, the content exchange system 200 can be included in the network environment 100 of FIG. 1. For example, the content exchange system 200 can be part of the content management system 110. In general, buyers can be offered the ability to decide how much they are willing to pay to show an ad in real time (e.g., “real-time bidding”). Sellers can have an interest in applying different pricing rules to different bidders; for example, some kinds of ads may negatively affect their site's user experience, so a seller may only be willing to show such an ad in exchange for a greater payment. Additionally, sellers may want to try and capture a greater share of their inventory's value by charging high prices for valuable inventory. However, unlike buyers, sellers may generally be constrained to specifying their pricing rules (e.g., how much buyers must pay, at minimum, to show ads of various types in various situations) in advance. As will be discussed below in the descriptions of FIGS. 2 and 3, the content exchange system 200 can provide sellers with real-time flexibility similar to that offered to buyers.

The content exchange system 200 identifies a candidate content item 202, such as an advertisement that can be included in a web page, media presentation or other appropriate resource. A collection of content features 204 associated with the candidate content item 202 is identified by the content exchange system 200.

The collection of content features 204 includes information that describes the candidate content item 202. The collection of content features 204 can include information such as the content item's format (e.g., text, image, video, audio), size, duration, functionality (e.g., the ad is static until clicked or hovered, the ad plays a media clip automatically, the ad is completely static), subject matter (e.g., the type of product, good, or service being advertised), intended customer audience (e.g., demographic information), developer of the content, links associated with the content, or combinations of these and other information that can describe the candidate content item 202. For example, the content features 204 may indicate that the candidate content item 202 is an advertisement for a political candidate, is intended for a male audience aged 30-40 years, is formed as a 30×70 pixel multimedia panel, and periodically plays a loop of audiovisual content.

The collection of content features 204 are provided to a pricing model 206. In some implementations, the pricing model 206 can be part of a system that is external to the content exchange system 200. For example, the pricing model 206 can be operated by the Web site 104a to estimate the possible negative impact and cost of presenting the content item 202 along with the resource 105.

The pricing model 206 determines a collection of surcharge factors 208 that are provided to the content exchange system 200. The surcharge factors 208 correspond to effects on the publisher of presenting the candidate content 202 on a portal, such as a Web site, television program, radio program, or other appropriate host in which advertising content can be included. For example, if presenting content has a negative effect on the publisher's business, the surcharge will be higher to represent the added burden on the publisher. In some implementations, the surcharge factors can be determined based on a type of the candidate content item 202, subject matter of the candidate content item 202, functionality of the candidate content item 202, a developer of the candidate content item 202, features included in the candidate content item 202, an industry associated with the candidate content item 202, whether the candidate content item 202 is for a competitor of the publisher, and links associated with the candidate content item 202. In some implementations, the surcharges can be determined using one or more linear classifiers that multiply values corresponding to one or more of the factors by corresponding weights and that process resulting products to produce the surcharges.

A collection of unadjusted bids 210 for the candidate content item 202 is obtained from content providers. The collection of unadjusted bids 210 corresponds to amounts that content providers will pay to present content on a portal hosted by a publisher. For example, the advertisers 108 may submit competing bids to present the candidate content item 202 on one or more of the Web sites 104 or in one or more broadcasts provided by the TV broadcasters 134.

The unadjusted bids 212 are adjusted in accordance with corresponding ones of the collection of surcharge factors 208 to produce the collection of adjusted bids 212. For example, one of the advertisers 108 may provide an unadjusted bid to place the candidate content item 202 on one or more of the web pages 104. The web pages 104, however, may include different content or address different audiences, and as a result the content features 204 of the candidate content item 202 may have a different effect and cost to each of those web pages 104. These different costs can be reflected in the surcharge factors 208 to determine the adjusted bids 212.

An auction 214 is performed based on the adjusted bids 212. In the auction 214, the adjusted bids 212 are compared to determine a winner of the auction 214 to present content on the portal hosted by the publisher. In various implementations, the incentive issues in online advertising auctions may differ, and so too may the auction type. For example, in a “first-price auction”, where the advertising space is sold to the highest bidder who pays the amount that they bid, bidders may have an incentive to bid “strategically”, e.g., to lower their bid to just above that of the next highest bidder in order to pay as little as possible. Thus, some online advertising auctions can be “second-price auctions” in which the highest bidder can pay the second-highest bid. Nevertheless, first-price auctions can be tempting to sellers of advertising, since they may capture the difference between the first and second prices in the short run. In examples such as these, it may be important to solve the above problem without giving sellers access to bids directly, or they may use the bids in a way that would induce buyers to bid strategically.

In some implementations, in order to allow the sellers to make incentive-compatible pricing decisions in real time, a system can be implemented in which sellers may not have access to the bids themselves. Instead, the sellers are provided with information about the candidate content item's 202 features, not including bids, and they can use the pricing model 206 to compute the surcharge factors 208 for each bid. The surcharge factors 208 are surcharges or bonuses that will be subtracted from or added to each ad's bid before it enters the auction 214. The surcharge factors 208 are applied, whereupon the bids enter the auction 214 and can compete in a second-price-auction.

Once the auction 214 has identified a winning content item 216, the price adjustment factors are applied to the price paid by the winning content item in reverse to compute an actual price 218 (e.g., how much the candidate content item 202 is charged).

In order to help sellers compute their pricing model 206, a report 220 is provided. In some implementations, the report 220 can include information that identifies the ad that won the auction 214 and the actual price 218 paid, but not the bids of non-winning ads back to the seller.

As an example, the following bids may be made:

Advertisement A: $3.00 CPM (cost per mille)

Advertisement B: $2.00 CPM

Advertisement C: $1.00 CPM

The features of advertisements A, B, and C can be provided to the pricing model 206, which can return, for example:

A: $1.75 surcharge

B: $0.50 surcharge

C: $0.10 bonus

Adjusted bids for A, B, and C can then be determined, such as:

Ad A: $1.25 aCPM (adjusted cost per mille)

Ad B: $1.50 aCPM

Ad C: $1.10 aCPM

The second price auction 214 can then be performed. The result would be advertisement B winning and paying an aCPM of $1.25. Then, advertisement B's surcharge would be re-applied, yielding an actual paid CPM of $1.75. The auction 214 in such examples can have a number of desirable properties. For example, the bidder may not ever pay more than they bid. Moreover, the auction can still be incentive-compatible. In another example, instead of a normal second price auction, the winner of the auction 214 can be the advertisement the seller most desires to show. As such, the features of real-time bidding can be extended to sellers substantially without encountering incentive-compatibility issues.

In some implementations, rather than call an external system (e.g., the pricing model 206), sellers can specify their pricing model to the content exchange system 200. The content exchange system 200 can verify the properties of the pricing model ahead of time, and provide bids in implementations in which the incentive-compatibility of the model could be confirmed in advance.

In some implementations, different tools other than surcharges or bonuses can be provided to sellers. For example, sellers can be allowed to set reserve prices, which would be similar to the surcharge/bonus model but would not allow “price inversion” among advertisements (e.g., the advertisement that wins can be the eligible content with the highest initial CPM).

FIG. 3 is a flow chart showing an example process 300 for determining the price of content, such as online advertising. Process 300 may be performed, e.g., by content management system 110 or the content exchange system 200.

At 305, bids are obtained from content providers. The bids correspond to amounts that the content providers will pay to present content on a portal hosted by a publisher. For example, the content exchange system 200 receives the collection of unadjusted bids 210 from bidders such as the advertisers 108.

At 310, surcharges corresponding to an effect on the publisher of presenting content from the content providers on the portal are obtained. For example the surcharge factors 208 can be obtained from the pricing model 206. In some implementations, surcharges can be different for different content providers, and the effect can be a cost borne by the publisher of presenting a content item from a content provider. In some implementations, the cost can be a monetary effect on a business of the content provider of presenting the content item. For example, an advertisement may have a negative impact upon a web page in which the ad is presented, and the magnitude of the negative impact may be defined in terms of the financial impact (e.g., the surcharge) that the ad has upon the web page or Web site in which it was presented. In another example, an advertisement may have a positive impact upon the Web site that presents the ad, and the positive impact may be described in terms of a monetary value (e.g., a bonus).

In some implementations, the content can be advertising, and the content providers can be advertisers. For example, the content providers can be the advertisers 108 who provide advertisements that can be managed by the content management system 110. In some implementations, the content providers can be Web site providers, the advertising can be an online advertisement, and the surcharges can be based on one or more of the following: whether the ad is expandable, subject matter of the ad, whether the ad includes pixel tags, an ad agency that developed the ad, whether the ad contains audio, whether the ad contains video, whether video contained in the ad starts when a page is loaded or requires interaction before starting, an industry that the ad represents, whether the ad is for a competitor of the publisher, and whether the ad clicks-through to a Web page that meets one or more predefined criteria regarding Web page quality. For example, the publisher of a high-quality web page may charge a surcharge for presenting an ad that links the user to a page of relatively lower quality.

In some implementations, the surcharges can be obtained from the publisher, and each surcharge can correspond to a content item from a content provider. At least one of the surcharges can be based on an adjusted bid of a winner of a prior auction. For example, the actual price 218 can be provided to the pricing model 206 as part of the reports 220.

In some implementations, the surcharges can be based on one or more of the following factors: a type of the content, subject matter of the content, functionality of the content, a developer of the content, features included in the content, an industry associated with the content, whether the content is for a competitor of the publisher, and links associated with the content. For example, the operator of a yoga Web site may charge a surcharge for presenting an advertisement that includes sound or flashy animation. In another example, the operator of an airline Web site may charge a surcharge for displaying an advertisement for a bus line (e.g., a competitor).

In some implementations, each of the surcharges can be determined using a linear classifier that multiplies values corresponding to one or more of the factors by corresponding weights and that processes resulting products to produce a surcharge. For example, the operator of a Web site may establish a pricing model (e.g., the pricing model 206) in which multimedia advertisements (e.g., as opposed to text ads) and advertisements for competitors are both to be charged a surcharge for their negative effects upon the Web site. Furthermore, the pricing model may reflect the Web site operator's philosophy that competitor's advertisements have a greater negative impact than do multimedia ads. As such, the surcharge associated with an advertisement belonging to a competitor may be given a relative greater mathematical weight than the weight given for the use of multimedia. The linear classifier can multiply the surcharges for the individual features of the ad by their respective weights to determine the total surcharge to be associated with the advertisement.

At 315, the bids are adjusted in accordance with corresponding surcharges to thereby produce adjusted bids. For example, the surcharge factors 208 and the unadjusted bids 210 are compared to provide the collection of adjusted bids 212.

If at 320 there are additional bids remaining, then the additional bids are obtained at 305. If there are no additional bids at 320, then at 325 the adjusted bids are compared to determine a winner of an auction to present content on the portal hosted by the publisher. For example, the auction 214 determines the winning content 216 that will be provided for inclusion in one of the web pages 104 or programs provided by the TV broadcasters 134.

At 330, a price for the winner to pay is determined based on the surcharge. In implementations in which a first price auction is used to determine the price, at 332 determining the price comprises adding, to an adjusted bid of the winner, a surcharge corresponding to the adjusted bid of the winner to produce the price.

In implementations in which a second price auction is used to determine the price, at 334 an adjusted bid of a content provider who placed second in the auction behind the winner is obtained, and a surcharge corresponding to the adjusted bid of the winner to produce the price is added to the adjusted bid of the content provider who placed second in the auction.

At 340, the winner is charged the price for presenting content on the portal. For example, the winner can be charged the actual price 218.

In some implementations, the content providers can be television providers, the advertising can be a television advertisement, and the surcharges can be based on one or more of the following: subject matter of the ad, an industry that the ad represents, and whether the ad is for a competitor of the publisher. For example, the advertising can be a commercial placed in the programming broadcast by one or more of the TV broadcasters 134.

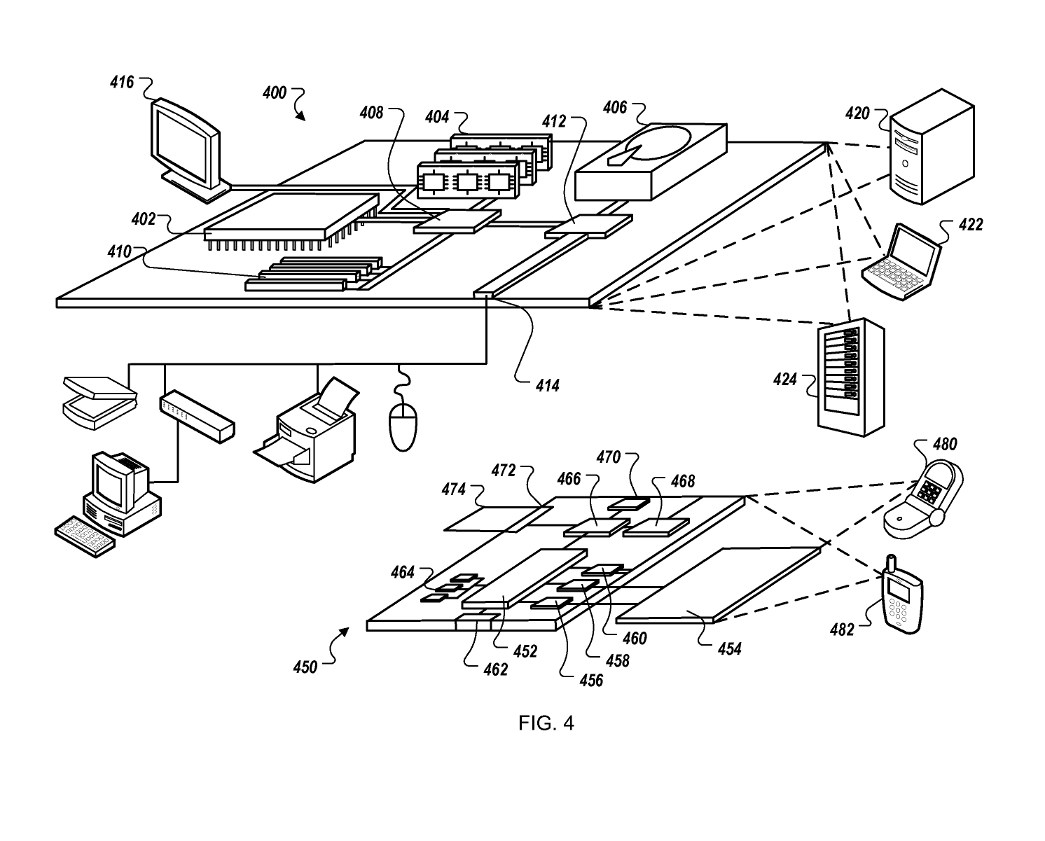

FIG. 4 shows an example of a generic computing device 400 and a generic mobile computing device 450, which may be used to implement all or part of the processes described herein. For example, content management system 110 and search system 112 may be implemented by computing device 400 and mobile computing device 450 may implement a user device 106/106a of FIG. 1. In this regard, computing device 400 is intended to represent various forms of digital computers, examples of which include laptops, desktops, workstations, personal digital assistants, servers, blade servers, mainframes, and other appropriate computers. Computing device 450 is intended to represent various forms of mobile devices, examples of which include personal digital assistants, cellular telephones, smartphones, and other similar computing devices. The components shown here, their connections and relationships, and their functions, are meant to be examples, and are not meant to limit the scope of the appended claims.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, for example, display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, examples of which include a magnetic or optical disk.

The storage device 406 is capable of providing mass storage for the computing device 400. In one implementation, the storage device 406 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, including those described above. The information carrier may be a non-transitory computer- or machine-readable medium, for example, the memory 404, the storage device 406, memory on processor 402, or a propagated signal. For example, the information carrier may be a non-transitory, machine-readable storage medium.

The high speed controller 408 manages bandwidth-intensive operations for the computing device 400, while the low speed controller 412 manages lower bandwidth-intensive operations. Such allocation of functions is an example. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, examples of which include a keyboard, a pointing device, a scanner, or a networking device, for example, a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer, for example, a laptop computer 422. Alternatively, components from computing device 400 may be combined with other components in a mobile device (not shown), for example, device 450. Each of such devices may contain one or more of computing device 400, 450, and an entire system may be made up of multiple computing devices 400, 450 communicating with each other.

Computing device 450 includes a processor 452, memory 464, an input/output device for example, a display 454, a communication interface 466, and a transceiver 468, among other components. The device 450 may also be provided with a storage device, for example, a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, for example, control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided by the SIMM cards, along with additional information, for example, placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, examples of which include those described above. The information carrier is a computer- or machine-readable medium, for example, the memory 464, expansion memory 474, memory on processor 452, or a propagated signal that may be received, for example, over transceiver 468 or external interface 462.

Device 450 may communicate wirelessly through communication interface 466, which may include digital signal processing circuitry where necessary. Communication interface 466 may provide for communications under various modes or protocols, examples of which include GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, for example, using a Bluetooth, Wi-Fi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, for example, through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems discussed herein collect personal information about users, the users may be provided with an opportunity to enable or disable programs or features that may collect personal information (e.g., information about a user's preferences or a user's current location). In addition, certain data may be anonymized in one or more ways before it is stored or used, so that personally identifiable information is removed. For example, a user's identity may be anonymized.

Elements of different implementations described herein may be combined to form other implementations not specifically set forth above. Elements may be left out of the processes, computer programs, Web pages, etc., described herein without adversely affecting their operation. In addition, the logic flows depicted in the figures do not require the particular order shown, or sequential order, to achieve desirable results. Various separate elements may be combined into one or more individual elements to perform the functions described herein.

Other implementations not specifically described herein are also within the scope of the following claims.

What is claimed is:

1. A method performed by one or more processing devices, comprising:
obtaining bids from content providers, the bids corresponding to amounts that the content providers will pay to present content on a portal hosted by a publisher;
obtaining surcharges corresponding to an effect on the publisher of presenting content from the content providers on the portal;
using the one or more processing devices to adjust the bids in accordance with corresponding surcharges to thereby produce adjusted bids;
comparing the adjusted bids to determine a winner of an auction to present content on the portal hosted by the publisher;
determining a price for the winner to pay based on the surcharge; and
charging the winner the price for presenting content on the portal.

2. The method of claim 1, wherein surcharges are different for different content providers, and wherein the effect comprises a cost borne by the publisher of presenting a content item from a content provider.

3. The method of claim 2, wherein the cost comprises a monetary effect on a business of the content provider of presenting the content item.

4. The method of claim 1, wherein surcharges are obtained from the publisher, each surcharge corresponding to a content item from a content provider, at least one of the surcharges being based on an adjusted bid of a winner of a prior auction.

5. The method of claim 1, wherein the surcharges are based on one or more of the following factors: a type of the content, subject matter of the content, functionality of the content, a developer of the content, features included in the content, an industry associated with the content, whether the content is for a competitor of the publisher, and links associated with the content.

6. The method of claim 5, wherein each of the surcharges is determined using a linear classifier that multiplies values corresponding to one or more of the factors by corresponding weights and that processes resulting products to produce a surcharge.

7. The method of claim 1, wherein the content comprises advertising, and wherein the content providers comprise advertisers.

8. The method of claim 7, wherein the content providers comprise Web site providers, the advertising comprises an online advertisement (ad), and the surcharges are based on one or more of the following: whether the ad is expandable, subject matter of the ad, whether the ad includes pixel tags, an ad agency that developed the ad, whether the ad contains audio, whether the ad contains video, whether video contained in the ad starts when a page is loaded or requires interaction before starting, an industry that the ad represents, whether the ad is for a competitor of the publisher, and whether the ad clicks-through to a Web page that meets one or more predefined criteria regarding Web page quality.

9. The method of claim 7, wherein the content providers comprise television providers, the advertising comprises a television advertisement (ad), and the surcharges are based on one or more of the following: subject matter of the ad, an industry that the ad represents, and whether the ad is for a competitor of the publisher.

10. The method of claim 1, wherein determining the price comprises adding, to an adjusted bid of the winner, a surcharge corresponding to the adjusted bid of the winner to produce the price.

11. The method of claim 1, wherein determining the price comprises:
obtaining an adjusted bid of a content provider who placed second in the auction behind the winner; and
adding, to the adjusted bid of the content provider who placed second in the auction, a surcharge corresponding to the adjusted bid of the winner to produce the price.

12. One or more machine-readable storage media storing instructions that are executable by one or more processing devices to perform operations comprising:
obtaining bids from content providers, the bids corresponding to amounts that the content providers will pay to present content on a portal hosted by a publisher;
obtaining surcharges corresponding to an effect on the publisher of presenting content from the content providers on the portal;
adjusting the bids in accordance with corresponding surcharges to thereby produce adjusted bids;
comparing the adjusted bids to determine a winner of an auction to present content on the portal hosted by the publisher;
determining a price for the winner to pay based on the surcharge; and
charging the winner the price for presenting content on the portal.

13. A system comprising:
memory storing instructions that are executable; and
one or more processing devices to execute the instructions to implement a content management system, the content management system for performing operations comprising:
obtaining bids from content providers, the bids corresponding to amounts that the content providers will pay to present content on a portal hosted by a publisher;
obtaining surcharges corresponding to an effect on the publisher of presenting content from the content providers on the portal;
adjusting the bids in accordance with corresponding surcharges to thereby produce adjusted bids;
comparing the adjusted bids to determine a winner of an auction to present content on the portal hosted by the publisher;
determining a price for the winner to pay based on the surcharge; and
charging the winner the price for presenting content on the portal.
